(19) United States
(12) Patent Application Publication
(10) Pub. No.: US 2014/0337710 A1
(43) Pub. Date: Nov. 13, 2014

(54) ELECTRONIC DEVICE AND METHOD FOR PROCESSING DATA

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: CHUNG-I LEE, New Taipei (TW); DE-YI XIE, Shenzhen (CN); JIE HUANG, Shenzhen (CN)

(73) Assignees: HONG FU JIN PRECISION INDUSTRY (ShenZhen) CO., LTD., Shenzhen (CN); HON HAI PRECISION INDUSTRY CO., LTD., New Taipei (TW)

(21) Appl. No.: 14/273,497

(22) Filed: May 8, 2014

(30) Foreign Application Priority Data
May 10, 2013 (CN) 2013101723643

(51) Int. Cl. G06F 17/22

(52) U.S. Cl. CPC G06F 17/2247
USPC 715/234

(57) ABSTRACT

Method of processing data includes acquiring data of flow nodes of a specified flow from the electronic device, when the specified flow is executed in the electronic device. Based on the acquired data of the flow nodes, graphics data is determined. A first display area on a display device is created for displaying the graphics data. The graphics data is loaded on the first display area. Based on the graphics data, a process flow diagram is generated. The process flow diagram is displayed on the first display area.

### FIELD

Embodiments of the present disclosure relate to data processing technology, and particularly to an electronic device and a method for processing data using the electronic device.

### BACKGROUND

During a software developing process, an Unified Modeling Language (UML) model of a flow represented by characters and tables, is displayed on a display device for users. However, some specified data of the flow cannot be seen on the display device, for example, the users may not know who executes flow nodes of the flow.

### BRIEF DESCRIPTION OF THE DRAWINGS

FIG. 1 is a block diagram of one embodiment of an electronic device including a data processing system.

FIG. 2 is a block diagram of one embodiment of function modules of the data processing system in the electronic device of FIG. 1.

FIG. 3 illustrates a flowchart of one embodiment of a method for processing data in the electronic device of FIG. 1.

FIG. 4 illustrates a schematic diagram of one embodiment of data of flow nodes of a flow.

FIG. 5 illustrates a schematic diagram of one embodiment of a visualization process flow graphics.

FIG. 6 illustrates a schematic diagram of one embodiment of displaying graphics data and attribute data of the flow.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module,” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable storage medium or other computer storage device.

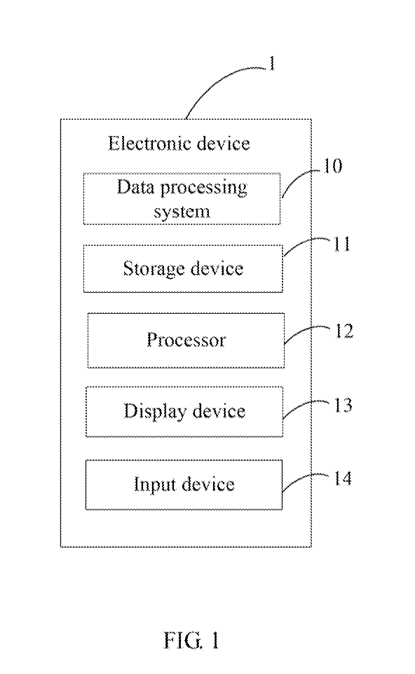

FIG. 1 is a block diagram of one embodiment of an electronic device 1 including a data processing system 10 (hereinafter “the system 10”). The electronic device 1 further includes a storage device 11, at least one processor 12, a display device 13, and an input device 14. The electronic device 1 may be a computer, a smart phone, a personal digital assistant (PDA), or other electronic device. FIG. 1 illustrates only one example of the electronic device 1 and can include more or fewer components than illustrated, or have different configurations of the various components in other embodiments.

The system 10 can dynamically load data of a flow on the display device 13, and can display a process flow diagram using graphics on the display device 13 for viewers.

In one embodiment, the storage device 11 may include various types of non-transitory computer-readable storage medium, such as a hard disk, a compact disc, a digital video disc, or a tape drive. The display device 13 may display images and videos, and the input device 14 may be a mouse or a keyboard for input.

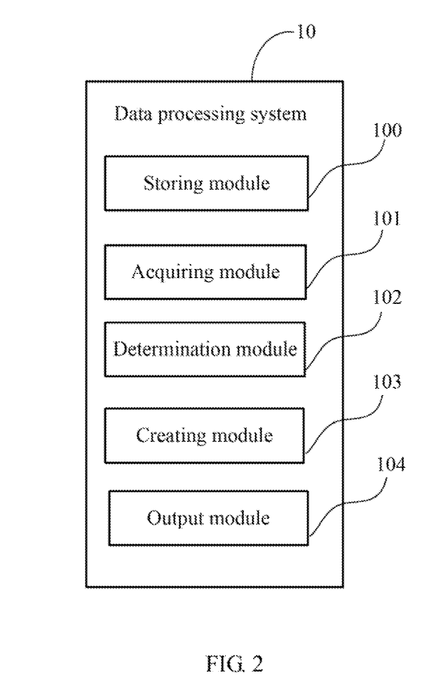

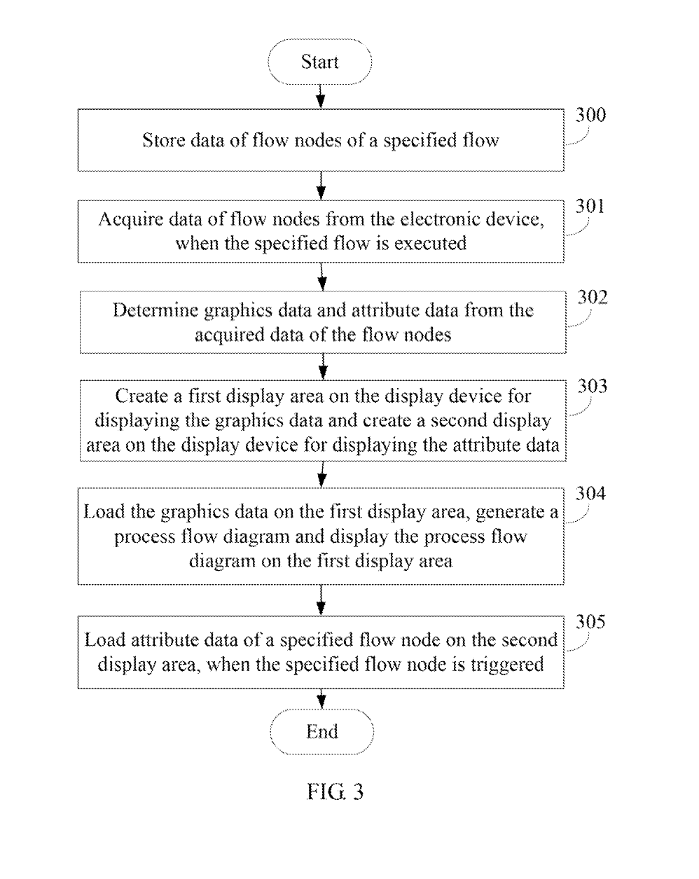

FIG. 2 is a block diagram of one embodiment of function modules of the system 10. In at least one embodiment, the system 10 may include a storing module 100, an acquiring module 101, a determination module 102, a creating module 103, and an output module 104. The function modules 100-104 may include computerized codes in the form of one or more programs, which are stored in the storage device 11. The at least one processor 12 executes the computerized codes to provide functions of the function modules 100-104. A detailed description of the function modules 100-104 is given with reference to FIG. 3.

FIG. 3 illustrates a flowchart of one embodiment of a method for processing data in the electronic device 1 of FIG. 1. Depending on the embodiment, additional steps may be added, others removed, and the ordering of the steps may be changed.

In 300, the storing module 100 stores data of flow nodes of a specified flow in the storage device 11. In some embodiment, before storing the data of the flow nodes in the storage device 11, the storing module 100 checks whether the data of the flow nodes of the specified flow is following predetermined rules. The flow nodes include a start node, an end node, and branch nodes. The data of the flow nodes may include, but is not limited to, identifications (IDs) of the flow nodes and tags of the flow nodes. The predetermined rules determine that each of the flow nodes has an ID, and the tag of each of the flow nodes is integrated.

When the data of the flow nodes of the specified flow is following the predetermined rules, the storing module 100 stores the data of the flow nodes in a text file, an Extensible Markup Language (XML™) file, an Access™ database, Structured Query Language (SQL™) database, or an Oracle™ database of the storage device 11. When the data of the flow nodes of the specified flow has not following the predetermined rules, the storing module 100 does not store the data of the flow nodes. In some embodiments, the storing module 100 may output a prompt to indicate that why the data of the flow nodes of the specified flow has not following the predetermined rules. Based on the prompt, people can amend the data of the flow nodes until the data of the flow nodes can be stored.

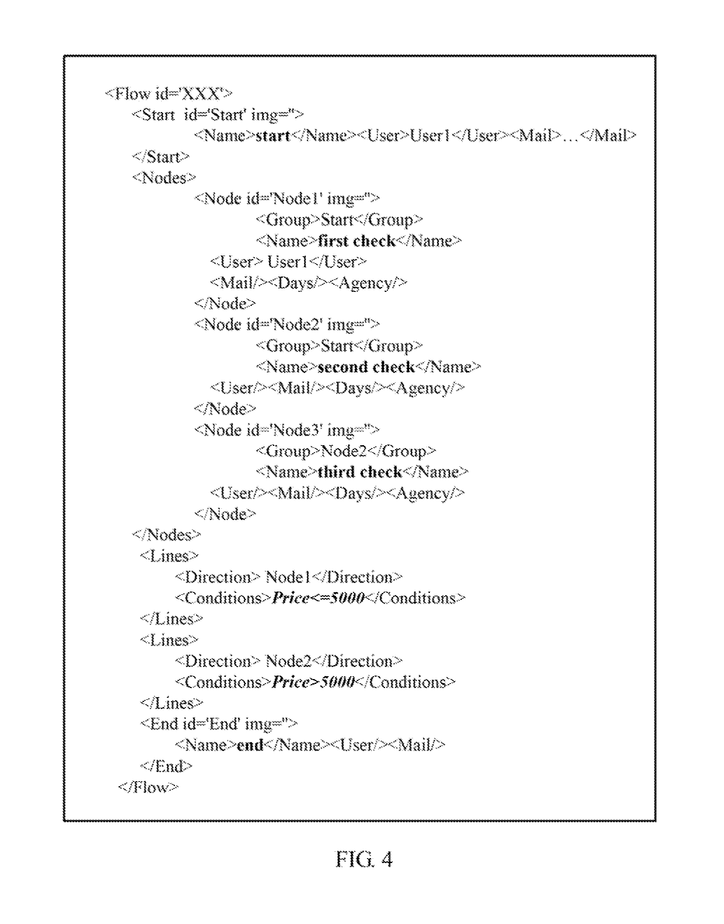

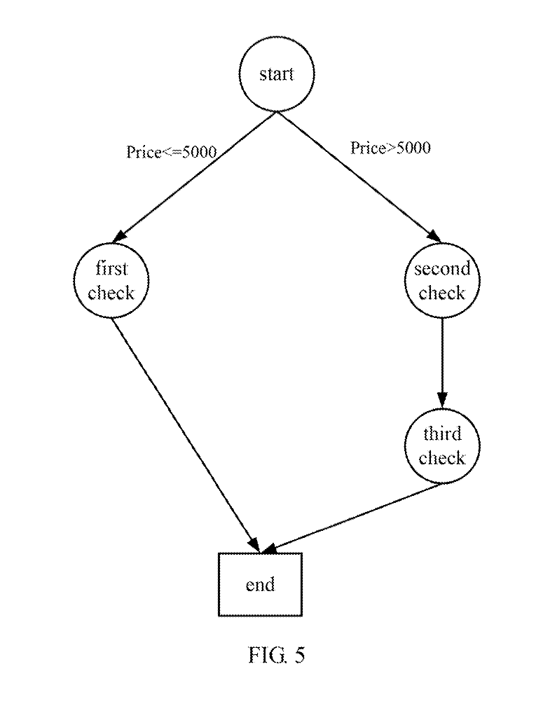

An example of data of flow nodes of a flow is shown in FIG. 4. A tag “Flow” represents flow data, a tag “Start” represents a start node, a tag “End” represents an end node, a tag “ID” represents an unique identification of a flow node, a tag “img” represents an icon of a flow node (e.g., “img=start.jep” for displaying an icon for “Start” node), a tag “Name” represents a name of the flow node, a tag “User” represents a user who executes the flow, a tag “Mail” represents a mail address of the user, a tag “CopyMail” represents another user who needs to receive a copy of a mail. A tag “Nodes” represents a set of branch nodes, a tag “Group” represents a parent node, a tag “Lines” represents a flow line, a tag “Direction” represents a flow line that points to a flow node, a tag “Conditions” represents a logical determination. According to predetermined determinations defined by people, the flow is executed by selecting a next flow node of a current flow node automatically. As shown in FIG. 5, if a current flow node is “start” and a condition is “Price<=5000”, the next flow node is “first check”. If a current flow node is “start” and a condition is “Price>5000”, the next flow node is “second check”.

In 301, when the specified flow is executed in the electronic device, the acquiring module 101 acquires the data of the flow nodes of the specified flow from the storage device 11. The data of the flow nodes is loaded in a memory of the electronic device 1.

In 302, the determination module 102 determines graphics data and attribute data from the data of the flow nodes. In some embodiments, the graphics data includes, but is not limited to, a start node, an end node, branch nodes, and flow lines. For example, a character string “<Start> . . . </Start>” represents data of the start node, a character string “<End> . . . </End>” represents data of the end node, a character string “<Node> . . . </Node>” represents data of a branch node, a character string “<line> . . . </line>” represents data of a flow line. The attribute data includes a name of the flow node (e.g., second check), a user who executes the flow, contact information of the user and a deputy of the user.

In 303, the creating module 103 creates a first display area on the display device 13 for displaying the graphics data, and creates a second display area on the display device 13 for displaying the attribute data.

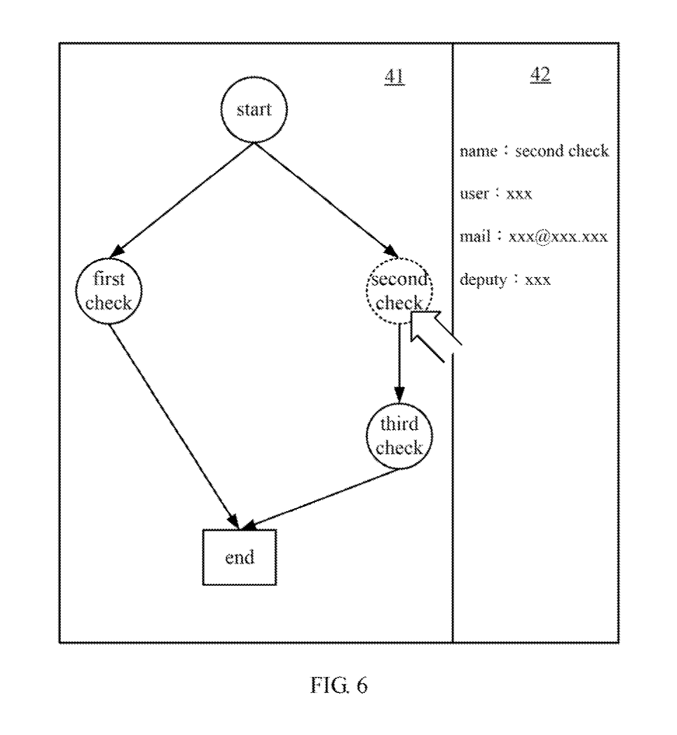

In 304, the output module 104 loads the graphics data on the first display area and generates a process flow diagram based on the graphics data. The process flow diagram includes flow nodes, flow lines and other graphics data. The output module 104 displays the process flow diagram on the first display area by a way of “<div>start node information</div><div>branch node information</div><div>end node information</div>”. For example, FIG. 5 shows a process flow diagram, and the process flow diagram is displayed in a first area 41 shown in FIG. 6.

In 305, when a specified flow node is triggered, the output module 104 loads attribute data of the specified flow node in the second display area. As shown in FIG. 6, when a specified flow node “second check” is clicked, the output module 104 displays attribute data of the specified flow node “second check” on a second display area 42 as shown in FIG. 6. The attribute data of the specified flow node “second check” includes a name of the specified flow node “second check”, a user who executes the specified flow node “second check”, mail address(es) of the user ,and a deputy of the user. In some embodiments, the output module 104 displays the attribute data of the specified flow node on the second display area using a web tag (e.g., <div></div>, <table></table>) and the attribute data is represented as “<table><tr><td> the user</td></tr><tr><td>mail addresses</td></tr></table>.”

In other embodiments, the creating module 103 may create a single display area. The output module 104 can display the graphics data and attribute data in the single display area.

It should be emphasized that the above-described embodiments of the present disclosure, including any particular embodiments, are merely possible examples of implementations, set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and protected by the following claims.

What is claimed is:

1. A computerized method for processing data being executed by at least one processor of an electronic device, the method comprising:
acquiring data of flow nodes of a specified flow from the electronic device, when the specified flow is executed in the electronic device;
determining graphics data from the acquired data of the flow nodes;
creating a first display area on a display device of the electronic device for displaying the graphics data;
loading the graphics data on the first display area and generating a process flow diagram based on the graphics data; and
displaying the process flow diagram on the first display area.

2. The method according to claim 1, wherein the graphics data of the flow nodes comprises a start node, an end node, branch nodes and flow lines.

3. The method according to claim 1, the method further comprising:
determining attribute data from the acquired data of the flow nodes;
creating a second display area on the display device for displaying the attribute data;
loading attribute data of a specified flow node on the second display area, when the specified flow node is triggered.

4. The method according to claim 3, wherein the attribute data of the specified flow node comprises a name of the specified flow node, a user who executes the flow, contact information of the user and a deputy of the user.

5. The method according to claim 1, further comprising:
checking whether the acquired data of the flow nodes of the specified flow is following predetermined rules;
storing the acquired data of the flow nodes of the specified flow in the electronic device when the data of the flow nodes is following the predetermined rules.

6. The method according to claim 5, wherein the acquired data of the flow nodes comprises identifications (IDs) of the flow nodes and tags of the flow nodes, the predetermined rules determine that each of the flow nodes has an ID, and the tags of the flow nodes are integrated.

7. An electronic device, comprising:
a processor; and
a storage device that stores one or more programs, when executed by the at least one processor, cause the at least one processor to perform a method for processing data, the method comprising:
acquiring data of flow nodes of a specified flow from the electronic device, when the specified flow is executed in the electronic device;
determining graphics data from the acquired data of the flow nodes;
creating a first display area on a display device of the electronic device for displaying the graphics data;
loading the graphics data on the first display area and generating a process flow diagram based on the graphics data; and
displaying the process flow diagram on the first display area.

8. The electronic device according to claim 7, wherein the graphics data of the flow nodes comprises a start node, an end node, branch nodes and flow lines.

9. The electronic device according to claim 7, the method further comprising:
determining attribute data from the acquired data of the flow nodes;
creating a second display area on the display device for displaying the attribute data;
loading attribute data of a specified flow node on the second display area, when the specified flow node is triggered.

10. The electronic device according to claim 9, wherein the attribute data of the specified flow node comprises a name of the specified flow node, a user who executes the flow, contact information of the user and a deputy of the user.

11. The electronic device according to claim 7, the method further comprising:
checking whether the acquired data of the flow nodes of the specified flow is following predetermined rules;
storing the acquired data of the flow nodes of the specified flow in the electronic device when the data of the flow nodes is following the predetermined rules.

12. The electronic device according to claim 11, wherein the acquired data of the flow nodes comprises identifications (IDs) of the flow nodes and tags of the flow nodes, the predetermined rules determine that each of the flow nodes has an ID, and the tags of the flow nodes are integrated.

13. A non-transitory storage medium having stored thereon instructions that, when executed by a processor of an electronic device, causes the processor to perform method for processing data in the electronic device, wherein the method comprises:
acquiring data of flow nodes of a specified flow from the electronic device, when the specified flow is executed in the electronic device;
determining graphics data from the acquired data of the flow nodes;
creating a first display area on a display device of the electronic device for displaying the graphics data;
loading the graphics data on the first display area and generating a process flow diagram based on the graphics data; and
displaying the process flow diagram on the first display area.

14. The non-transitory storage medium according to claim 13, wherein the graphics data of the flow nodes comprises a start node, an end node, branch nodes and flow lines.

15. The non-transitory storage medium according to claim 13, the method further comprises:
determining attribute data from the acquired data of the flow nodes;
creating a second display area on the display device for displaying the attribute data;
loading attribute data of a specified flow node on the second display area, when the specified flow node is triggered.

16. The non-transitory storage medium according to claim 15, wherein the attribute data of the specified flow node comprises a name of the specified flow node, a user who executes the flow, contact information of the user and a deputy of the user.

17. The non-transitory storage medium according to claim 13, the method further comprising:
checking whether the acquired data of the flow nodes of the specified flow is following predetermined rules;
storing the acquired data of the flow nodes of the specified flow in the electronic device when the data of the flow nodes is following the predetermined rules.

18. The non-transitory storage medium according to claim 17, wherein the acquired data of the flow nodes comprises identifications (IDs) of the flow nodes and tags of the flow nodes, the predetermined rules determine that each of the flow nodes has an ID, and the tags of the flow nodes are integrated.
